(19) United States
(12) Patent Application Publication
(10) Pub. No.: US 2007/0206133 A1
(43) Pub. Date: Sep. 6, 2007

(54) DISPLAY PANEL ASSEMBLY

(75) Inventors: Akira Hirai, Seongnam-si (KR); Kyeong-Hyeon KIM, Seongnam-si (KR)

Correspondence Address: CANTOR COLBURN, LLP, 55 GRIFFIN ROAD SOUTH, BLOOMFIELD, CT, 06002, US

(73) Assignee: SAMSUNG ELECTRONICS CO., LTD., Suwon-si (KR)

(21) Appl. No.: 11/671,523

(22) Filed: Feb. 6, 2007

(30) Foreign Application Priority Data
Feb. 7, 2006 (KR) 2006-11714

(51) Int. Cl. G02F 1/1335; G02F 1/1333

(52) U.S. Cl. 349/96

(57) ABSTRACT

A large-sized display panel assembly includes an upper polarizing sheet, a lower polarizing sheet, a display panel and a polarizing axis changing unit. The upper polarizing sheet includes a first polarizing axis. The lower polarizing sheet faces the upper polarizing sheet and includes a second polarizing axis having a same direction as the first polarizing axis. The display panel is disposed between the upper and lower polarizing sheets and changes a light-transmissivity to display images. The polarizing axis changing unit is disposed between the upper and lower polarizing sheets and rotates the polarized light 90 degrees with respect to a predetermined direction.

The present application claims priority to Korean Patent Application No. 2006-11714, filed on Feb. 7, 2006, and all the benefits accruing therefrom under 35 U.S.C. §119, the contents of which are hereby incorporated herein by reference in their entireties.

### BACKGROUND OF THE INVENTION

1. Field of the Invention

The present invention relates to a display panel assembly. More particularly, the present invention relates to the display panel assembly having a relatively larger size.

2. Description of the Related Art

A liquid crystal display (“LCD”) includes a LCD panel displaying images by using a light-transmissivity of a liquid crystal, and a backlight assembly disposed under the LCD panel and providing a light to the LCD panel.

The LCD panel includes a first substrate having a thin film transistor (“TFT”) formed thereon that is a switching element, a second substrate formed to face the first substrate and having a color filter formed thereon and a liquid crystal layer having liquid crystal molecules between the first and second substrates. In this case, the LCD panel mainly operates with a vertical alignment (“VA”) mode.

When an electric field is not formed between the first and second substrates, a longitudinal arrangement direction of liquid crystal molecules of the LCD panel operating in VA mode is perpendicular to the first and second substrates. However, when the electric field is generated between the first and second substrates, the longitudinal arrangement direction of liquid crystal molecules is parallel with the first and second substrates.

The LCD device further includes an upper polarizing sheet and a lower polarizing sheet that are disposed at an upper and lower portion of the LCD panel, respectively. In this case, to operate the LCD device in a normally black mode, the upper and lower polarizing sheets should have polarizing axes perpendicular to each other. For example, the upper and lower polarizing sheets have polarizing axes perpendicular to each other so that the LCD device blocks a light without the electric field and transmits the light when the electric field is formed.

According to an increase of the demand for a larger-sized TV, a large-sized LCD device is becoming more necessary. So, a size of the polarizing sheet should be commensurately larger.

To manufacture the polarizing sheet, raw materials are stretched to a first direction and are cut into a predetermined size. The polarizing sheet manufactured by the above process has a polarizing axis perpendicular to the first direction.

When the polarizing sheet is manufactured by the above process, the polarizing sheet including the polarizing axis perpendicular to the first direction, can have a relatively large size, for example over 80 inches, but the polarizing sheet including the polarizing axis parallel with the first direction, has a limitation for a larger size.

Therefore, when the polarizing sheet has the polarizing axis perpendicular to the first direction, the polarizing sheet can be a large size, but when the polarizing sheet has the polarizing axis parallel with the first direction, the polarizing sheet cannot have a large size and thus has a limitation for the large-sized LCD device.

### BRIEF SUMMARY OF THE INVENTION

An exemplary embodiment provides a display panel having a relatively larger size by matching a polarizing axis of upper polarizing sheet to that of lower polarizing sheet.

In an exemplary embodiment, the display panel assembly includes an upper polarizing sheet, a lower polarizing sheet, a display panel and a polarizing axis changing unit.

The upper polarizing sheet has a first polarizing axis. The lower polarizing sheet faces the upper polarizing sheet and has a second polarizing axis having a same direction as the first polarizing axis of the upper polarizing sheet. The display panel is disposed between the upper and lower polarizing sheets and changes a transmissivity of a light to display images. The polarizing axis changing unit is disposed between the upper and lower polarizing sheets and rotates a light polarized in a predetermined direction 90 degrees with respect to the predetermined direction.

In an alternative exemplary embodiment, the polarizing axis changing unit includes an upper substrate, a lower substrate facing the upper substrate and a polarizing axis changing liquid crystal layer disposed between the upper and lower substrates and rotates the polarized light 90 degrees with respect to the predetermined direction.

In an exemplary embodiment, the polarizing axis changing liquid crystal layer includes liquid crystal molecules and a longitudinal arrangement direction of liquid crystal molecules is parallel with the upper and lower substrates, the liquid crystal molecules being rotated 90 degrees from the lower substrate to the upper substrate. In an alternative embodiment, a longitudinal arrangement direction of liquid crystal molecules in the polarizing axis changing liquid crystal layer may be parallel with the upper and lower substrates, and the polarizing axis changing liquid crystal layer may include liquid crystal molecules that are arranged so as to have a slope of 45 degrees with respect to the predetermined direction.

In an alternative exemplary embodiment, the display panel includes a first substrate, a second substrate facing the first substrate and a liquid crystal layer having a plurality of liquid crystal molecules that are arranged between the first and second substrates. An arrangement direction of the liquid crystal molecules is changed by an electric field generated between the first and second substrates. A longitudinal arrangement direction of the liquid crystal molecules in the liquid crystal layer is perpendicular to the first and second substrates when the electric field is not generated.

In an exemplary embodiment, the first substrate includes a common electrode having a first voltage applied thereto and a pixel electrode having a second voltage applied thereto different from the first voltage to generate the electric field between the first and second substrates. In an alternative embodiment, one of the first and second substrates may include a first transparent electrode having a first voltage applied thereto and a second transparent electrode having a second voltage applied thereto, and generating the electric field between the first transparent electrode and the second transparent electrode.

As in the exemplary embodiments, the polarizing axis changing unit rotating the polarizing axis of the light 90 degrees is disposed between the upper and lower polarizing sheets, so that the upper and lower polarizing sheets can have the same polarizing axis and the display panel assembly can be relatively larger-sized.

### BRIEF DESCRIPTION OF THE DRAWINGS

The above and other features and advantages of the present invention will become more apparent by describing in detailed exemplary embodiments thereof with reference to the accompanying drawings, in which:

FIG. 1 is an exploded perspective view illustrating an exemplary embodiment of a display panel assembly according to the present invention;

FIG. 2 is a cross-sectional view taken along line I-I′ of FIG. 1;

FIG. 3 is a cross-sectional view illustrating the display panel assembly of FIG. 2 when an electric field is generated between a first and a second substrate;

FIG. 4 is a cross-sectional view illustrating another exemplary embodiment of a display panel assembly according to the present invention;

FIG. 5 is a cross-sectional view illustrating another exemplary embodiment of a display panel assembly according to the present invention;

FIG. 6 is a plan view illustrating a longitudinal arrangement direction of liquid crystal molecules in a polarizing axis changing unit in FIG. 5;

FIG. 7 is a cross-sectional view illustrating another exemplary embodiment of a display panel assembly according to the present invention;

FIG. 8 is a cross-sectional view illustrating the display panel assembly of FIG. 7 when an electric field is generated between a first and a second substrate;

FIG. 9 is a cross-sectional view illustrating another exemplary embodiment of a display panel assembly according to the present invention;

FIG. 10 is a cross-sectional view illustrating the display panel assembly of FIG. 9 when an electric field is generated between a first and a second substrate;

FIG. 11 is an enlarged cross-sectional view illustrating portion ‘A’ in FIG. 10;

FIG. 12 is a cross-sectional view illustrating another exemplary embodiment of a display panel assembly according to the present invention;

FIG. 13 is a cross-sectional view illustrating the display panel assembly of FIG. 12 when an electric field is generated between a first and a second substrate; and

FIG. 14 is an enlarged cross-sectional view illustrating portion ‘B’ in FIG. 13.

### DETAILED DESCRIPTION OF THE INVENTION

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity.

It will be understood that when an element or layer is referred to as being “on” another element or layer, it can be directly on the other element or layer or intervening elements or layers may be present. In contrast, when an element is referred to as being “directly on” another element or layer, there are no intervening elements or layers present. Like numbers refer to like elements throughout. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “lower,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “lower” relative to other elements or features would then be oriented “upper” relative to the other elements or features. Thus, the term “lower” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the invention are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, the present invention will be explained in detail with reference to the accompanying drawings.

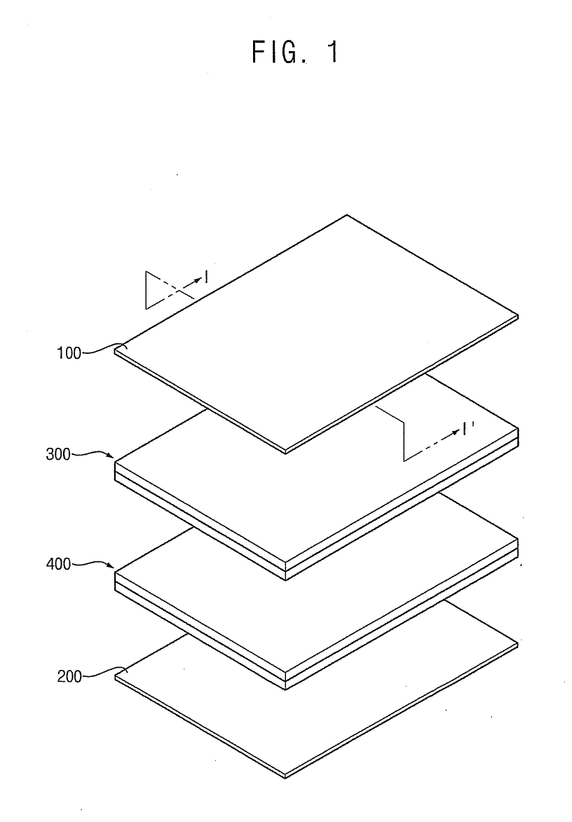

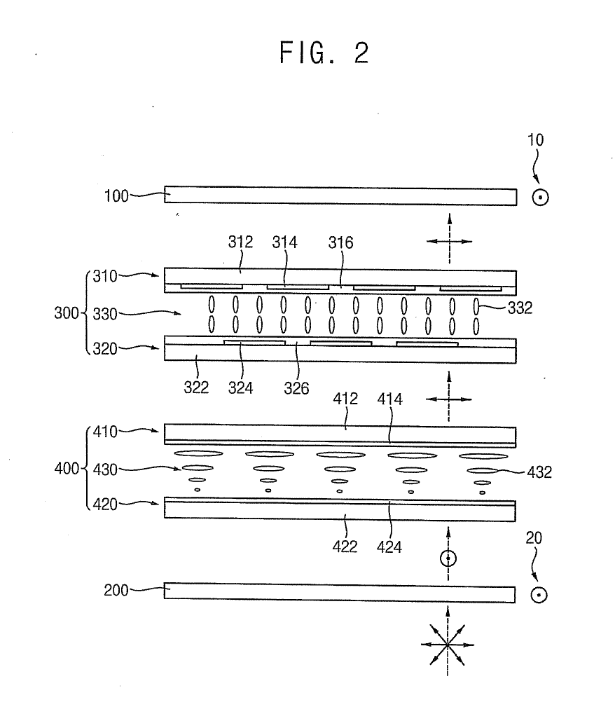

FIG. 1 is an exploded perspective view illustrating an exemplary embodiment of a display panel assembly according to the present invention and FIG. 2 is a cross-sectional view taken along line I-I′ of FIG. 1.

Referring to FIGS. 1 and 2, the display panel assembly includes an upper polarizing sheet 100, a lower polarizing sheet 200, a display panel 300 and a polarizing axis changing unit 400.

The upper polarizing sheet 100 has a substantially plate shape and includes a first polarizing axis 10 polarizing a light in a predetermined direction.

The lower polarizing sheet 200 is disposed under the upper polarizing sheet 100 to face the upper polarizing sheet 100. The lower polarizing sheet 200 has a substantially plate shape and includes a second polarizing axis 20 having the same direction as the first polarizing axis 10 of the upper polarizing sheet 100.

The display panel 300 is disposed between the upper and lower polarizing sheets 100 and 200 and changes a light-transmissivity to display images. The display panel 300 includes a first substrate 310, a second substrate 320 and a liquid crystal layer 330.

The first substrate 310 includes a first transparent substrate 312, a common electrode 314 and a first alignment film 316.

The first transparent substrate 312 has a substantially plate shape and includes a transparent material such as quartz, glass and so on.

The common electrode 314 is formed on the first transparent substrate 312 and includes a transparent conductive material. Exemplary embodiments of a material that can be used for the common electrode 314 may include indium tin oxide (ITO), indium zinc oxide (IZO), amorphous indium tin oxide (a-ITO), and so on.

The common electrode 314 has first opening portions that are formed through the common electrode and separated from each other by a predetermined distance. In one exemplary embodiment, after the common electrode 314 is formed on a front surface of the first transparent substrate 312, portions of the common electrode 314 are etched and the first opening portions are formed to be separated from each other by a predetermined distance.

The common electrode 314 has a first voltage applied thereto from an external voltage supply unit (not shown). In one exemplary embodiment, the first voltage is preferably a ground voltage.

The first alignment film 316 is formed on the first transparent substrate 312 and covers the common electrode 314.

In alternative exemplary embodiments, the first substrate 310 may further include color filters transmitting the light and displaying colors. The color filters, when viewed on a plane, are arranged in a substantially matrix shape. The color filters may include, but are not limited to, red color filters, green color filters, blue color filters and so on.

The second substrate 320 faces the first substrate 310 and includes a second transparent substrate 322, a pixel electrode 324 and a second alignment film 326.

The second transparent substrate 322 has a substantially plate shape, and may include the same transparent material, such as quartz, glass and so on, as the first transparent substrate 312.

The pixel electrode 324 is formed on the second transparent substrate 322 to face the common electrode 314. The pixel electrode 324 may include the same transparent conductive material as the common electrode 314.

The pixel electrode 324 is formed to correspond to the color filters that are formed on the first substrate 310. In one exemplary embodiment, the pixel electrode 324, when viewed on plane, is arranged in substantially a matrix shape.

The pixel electrode 324 has second opening portions that are formed through the pixel electrode 324 and the second opening portions are separated from each other by a predetermined distance. In one exemplary embodiment, after the pixel electrode 324 is formed on a front surface of the second transparent substrate 322, portions of the common electrode 324 are etched and the second opening portions are formed to be separated from each other by the predetermined distance. In exemplary embodiments, each of the second opening portions may be formed between adjacent first opening portions, preferably in a substantially middle position between the adjacent first opening portions.

The pixel electrode 324 has a second voltage different from the first voltage. The second voltage is applied from an external voltage supply unit (not shown). The second voltage is higher or lower than the first voltage. When the second voltage is applied to the pixel electrode 324, an electric field is generated between the common electrode 314 and the pixel electrode 324. However, when no voltage is applied to the pixel electrode 324, the electric field is not generated between the common electrode 314 and the pixel electrode 324.

The second alignment film 326 is formed on the second transparent substrate 322 to cover the pixel electrode 324.

The liquid crystal layer 330 has a plurality of liquid crystal molecules 332 that are arranged between the first and second substrates 310 and 320. An array shape of the liquid crystal layer 330 is changed by the electric field generated between the first and second substrates 310 and 320.

The liquid crystal molecules 332 are arranged by the first and second alignment film 316 and 326, when no electric field is generated. In the illustrated exemplary embodiment, a longitudinal arrangement direction of liquid crystal molecules 332 is substantially perpendicular to the first and second substrates 310 and 320 by the first and second alignment film 316 and 326, when no electric field is generated.

In the illustrated exemplary embodiment, the longitudinal arrangement direction of liquid crystal molecules 332 is substantially perpendicular to a direction of the electric field when the electric field is generated. In one exemplary embodiment, the liquid crystal molecules 332 are negative liquid crystal molecules having a characteristic of being arranged perpendicular to the direction of the electric field.

A polarizing axis changing unit 400 is disposed between the upper and lower polarizing sheet 100 and 200 and rotates a light polarized in a direction 90 degrees with respect to the direction.

Referring to FIG. 2 the polarizing axis changing unit 400 is disposed between the lower polarizing sheet 200 and the display panel 300 and rotates a light passing through the lower polarizing sheet 200 90 degrees with respect to the second polarizing axis 20 of the lower polarizing sheet 200.

The polarizing axis changing unit 400 includes an upper substrate 410, a lower substrate 420 and a polarizing axis changing liquid crystal layer 430.

The upper substrate 410 includes an upper transparent substrate 412 and an upper alignment film 414. The upper transparent substrate 412 has a substantially plate shape and may include a transparent material such as quartz, glass and so on. The upper alignment film 414 may be formed on a whole surface of the upper transparent substrate 412 as illustrated in FIG. 2.

The lower substrate 420 faces the upper substrate 410 and includes a lower transparent substrate 422 and a lower alignment film 424. The lower transparent substrate 422 has a substantially plate shape and may include the same transparent material such as quartz, glass and so on, as the upper transparent substrate 412. The lower alignment film 424 also may be formed on a whole surface of the lower transparent substrate 422 to face the upper alignment film 414.

The polarizing axis changing liquid crystal layer 430 is disposed between the upper and lower substrates 410 and 420 for rotating a polarizing axis of a light 90 degrees. As in the illustrated exemplary embodiment, the polarizing axis changing liquid crystal layer 430 includes liquid crystal molecules 432 of a twist negative (“TN”) mode. In one exemplary embodiment, a longitudinal arrangement direction of the liquid crystal molecules 432 in the polarizing axis changing liquid crystal layer 430 is substantially parallel with the upper and lower substrates 410 and 420, and are gradually rotated to 90 degrees from the lower substrate 410 toward the upper substrate 420.

Referring to FIG. 2 again, an advancing path of the light will be explained. The light that is emitted from a lower portion of the lower polarizing sheet 200, passes through the lower polarizing sheet 200 and is polarized to have a first direction substantially parallel with the second polarizing axis 20. The light that has been polarized to have the first direction passes through the polarizing axis changing unit 400 and is rotated 90 degrees with respect to the first direction, to be polarized to have a second direction substantially perpendicular to the first direction. The light that has been polarized to have the second direction passes through the display panel 300 without the electric field. The light passing through the display panel 300, since the light has been polarized to have the second direction, cannot pass through the upper polarizing sheet 100 having the first polarizing axis 10 substantially parallel with the first direction.

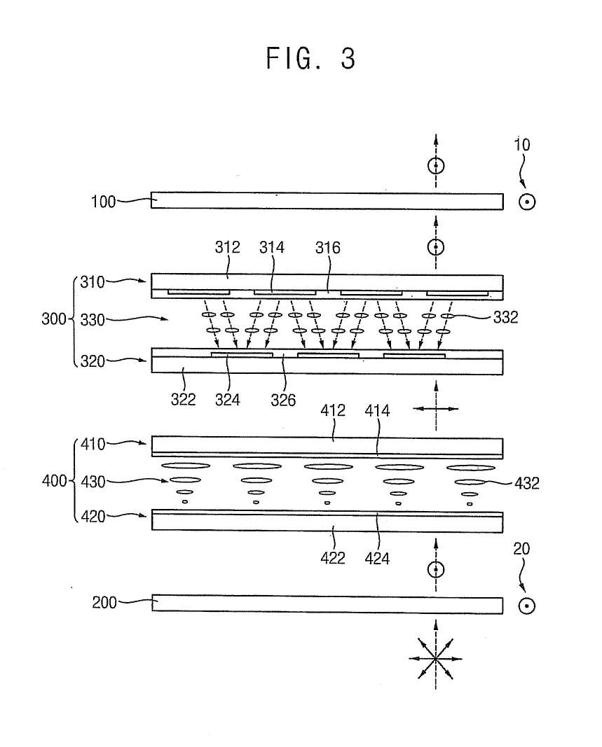

FIG. 3 is a cross-sectional view illustrating the display panel assembly in FIG. 2 when an electric field is generated between the first and second substrates. Referring to FIG. 3, the advancing path of the light Will be explained when the electric field is generated in the display panel 300.

The light that is emitted from a lower portion of the lower polarizing sheet 200, passes through the lower polarizing sheet 200, to be polarized to have the first direction parallel with the second polarizing axis 20. The light that has been polarized to have the first direction passes through the polarizing axis changing unit 400 and is rotated 90 degrees with respect to the first direction, to be polarized to have the second direction. The light that has been polarized to have the second direction passes through the display panel 300 with the electric field and is rotated 90 degrees with respect to the second direction, to be polarized to have the first direction again. The light polarized to have the first direction passes through the upper polarizing sheet 100 having the first polarizing axis 10 parallel with the first direction.

As in the illustrated exemplary embodiment, the polarizing axis changing unit 400, rotating the polarizing axis of the light 90 degrees, is disposed between the lower polarizing sheet 200 and the display panel 300, so that the upper and lower polarizing sheets 100 and 200 have the same polarizing axis. When the upper and lower polarizing sheets 100 and 200 have the same polarizing axis, the upper and lower polarizing sheets 100 and 200 may be relatively larger in size, such as more than 80 inches. Advantageously, the display panel assembly having the upper and lower polarizing sheets 100 and 200 may have a relatively larger size.

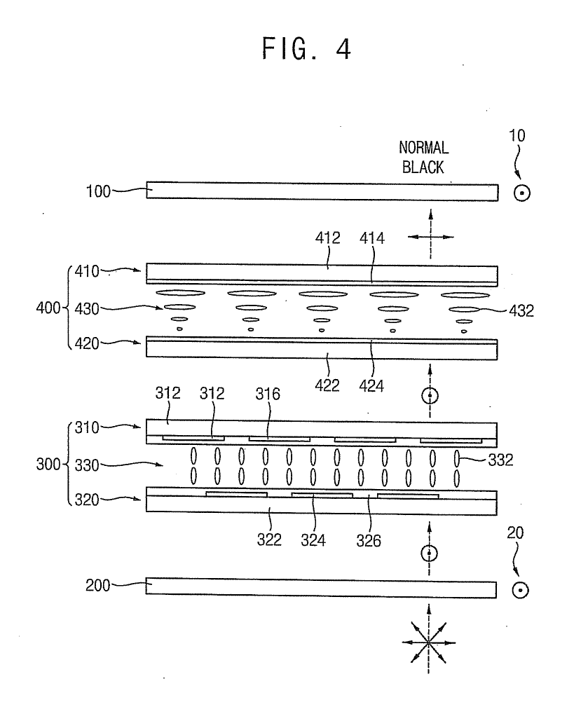

FIG. 4 is a cross-sectional view illustrating another exemplary embodiment of a display panel assembly according to the present invention. In the illustrated exemplary embodiment, the display panel assembly is the same as in FIGS. 2 and 3 except for a position of the polarizing axis changing unit. Thus, the same reference numerals will be used to refer to the same or like parts as those described in FIGS. 2 and 3 and any further repetitive explanation concerning the above elements will be omitted.

Referring to FIG. 4, the display panel assembly includes an upper polarizing sheet 100, a lower polarizing sheet 200, a display panel 300 and a polarizing axis changing unit 400.

The upper polarizing sheet 100 includes a first polarizing axis 10 polarizing a light in a predetermined direction. The lower polarizing sheet 200 is disposed under the upper polarizing sheet 100 to face the upper polarizing sheet 100, and includes a second polarizing axis 20 having the same direction as the first polarizing axis 10 of the upper polarizing sheet 100.

The display panel 300 is disposed between the upper and lower polarizing sheets 100 and 200, and changes a light-transmissivity to display images. The display panel 300 includes a first substrate 310, a second substrate 320 and a liquid crystal layer 330.

The polarizing axis changing unit 400 is disposed between the upper and lower substrates 100 and 200 and rotates a light polarized in a direction 90 degrees with respect to the direction. In the illustrated exemplary embodiment, the polarizing axis changing unit 400 is disposed between the upper polarizing sheet 100 and the display panel 300 and rotates a polarizing axis of a light passing through the display panel 90 degrees.

As in the illustrated exemplary embodiment, the polarizing axis changing unit 400 that rotates the polarizing axis of the light 90 degrees, is disposed between the upper polarizing sheet 100 and the display panel 300, so that the upper and lower polarizing sheet 100 and 200 can have the same polarizing axis with each other and the display panel assembly can have a relatively larger size.

However, when the polarizing axis changing unit 400 is disposed between the upper polarizing sheet 100 and the display panel 300, since a viewing-angle within which images are displayed may be reduced, the polarizing axis changing unit 400 disposed between the lower polarizing sheet 200 and the display panel 300 is more preferable as explained with respect to FIGS. 1 and 2.

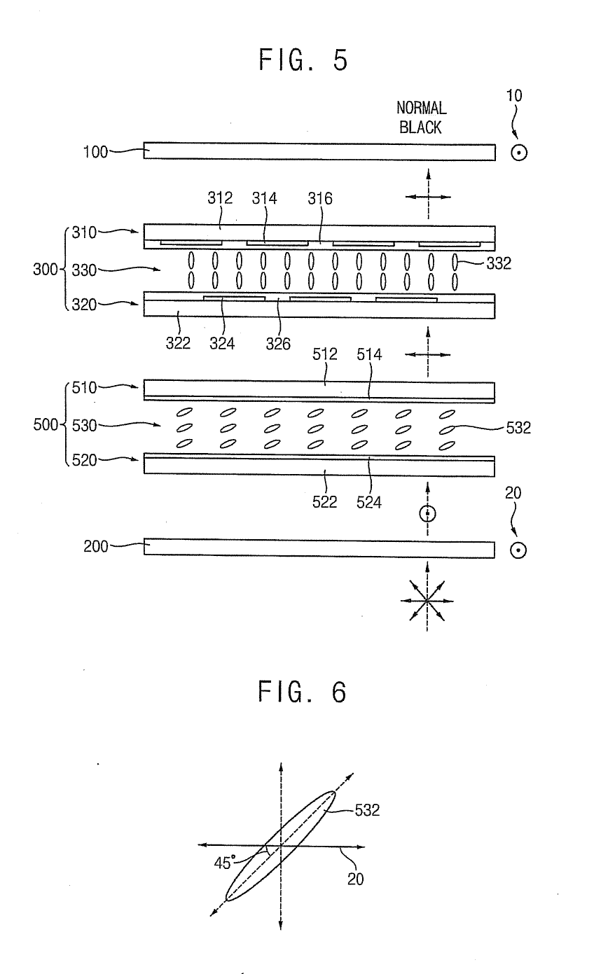

FIG. 5 is a cross-sectional view illustrating another exemplary embodiment of a display panel assembly according to the present invention. In the illustrated exemplary embodiment, the display panel assembly is the same as in FIGS. 2 and 3 except for the liquid crystal molecules of the polarizing axis changing unit. Thus, the same reference numerals will be used to refer to the same or like parts as those described in FIGS. 2 and 3 and any further repetitive explanation concerning the above elements will be omitted.

Referring to FIG. 5, the display panel assembly includes an upper polarizing sheet 100, a lower polarizing sheet 200, a display panel 300 and a polarizing axis changing unit 500.

The upper polarizing sheet 100 includes a first polarizing axis 10 polarizing a light in a predetermined direction. The lower polarizing sheet 200 is disposed under the upper polarizing sheet 100 and faces the upper polarizing sheet 100. The lower polarizing sheet 200 includes a second polarizing axis 20 having the same direction as the first polarizing axis 10 of the upper polarizing sheet 100.

The display panel 300 is disposed between the upper and lower polarizing sheets 100 and 200, for changing a light-transmissivity to display images. The display panel 300 includes a first substrate 310, a second substrate 320 and a liquid crystal layer 330.

The polarizing axis changing unit 500 is disposed between the upper and lower substrates 100 and 200, for rotating a light polarized in a direction 90 degrees with respect to the direction. In the illustrated exemplary embodiment, the polarizing axis changing unit 500 is disposed between the lower polarizing sheet 200 and the display panel 300, for rotating a polarizing axis of a light passing through the lower polarizing sheet 200 90 degrees.

The polarizing axis changing unit 500 includes an upper substrate 510, a lower substrate 520 and a polarizing axis changing liquid crystal layer 530.

The upper substrate 510 includes an upper transparent substrate 512 and an upper alignment film 514. The upper transparent substrate 512 may include a transparent material such as quartz, glass and so on, and is formed on a front surface of the upper transparent substrate 512.

The lower substrate 520 faces the upper substrate 510 and includes a lower transparent substrate 522 and a lower alignment film 524. The lower transparent substrate 522 may include a transparent material such as quartz, glass and so on, and is formed on a front surface of the lower transparent substrate 522, for facing the upper alignment film 514.

The polarizing axis changing liquid crystal layer 530 is disposed between the upper and lower substrates 510 and 520 for rotating a polarizing axis of a light 90 degrees. In one exemplary embodiment, a longitudinal arrangement direction of liquid crystal molecules 532 in the polarizing axis changing liquid crystal layer 530 is substantially parallel with the upper and lower substrates 510 and 520, and includes liquid crystal molecules that are arranged so as to have a slope of about 45 degrees with respect to the second polarizing axis 20.

FIG. 6 is a plan view illustrating a longitudinal arrangement direction of liquid crystal molecules in the polarizing axis changing unit in FIG. 5.

Referring to FIG. 6, an arrangement of the liquid crystal molecules 532 will be explained. The longitudinal arrangement direction of liquid crystal molecules in a polarizing axis changing liquid crystal layer 530 is substantially parallel with the upper and lower substrates 510 and 520. Each liquid crystal molecule 532 is arranged so as to have a slope of about 45 degrees with respect to the second polarizing axis 20.

The liquid crystal molecules 532 that are arranged so as to have the slope of about 45 degrees with respect to the second polarizing axis 20, rotates the polarizing axis of the light passing through the lower polarizing sheet 200 90 degrees. In the illustrated exemplary embodiment, the light that has passed through the lower polarizing sheet 200 and has been polarized to have the second polarizing axis 20, passes through the liquid crystal molecules 532 that are arranged so as to have the slope of 45 degrees, so that the polarizing axis of the light is rotated 90 degrees. As illustrated in the exemplary embodiment in FIG. 5, the polarizing axis changing unit 500 is disposed between the lower polarizing sheet 200 and the display panel 300, includes liquid crystal molecules 532 that are arranged so as to have a slope of about 45 degrees, and rotates the polarizing axis of the light 90 degrees, so that the upper and lower polarizing sheets 100 and 200 can have the same polarizing axis with each other and the display assembly can have a relatively larger size.

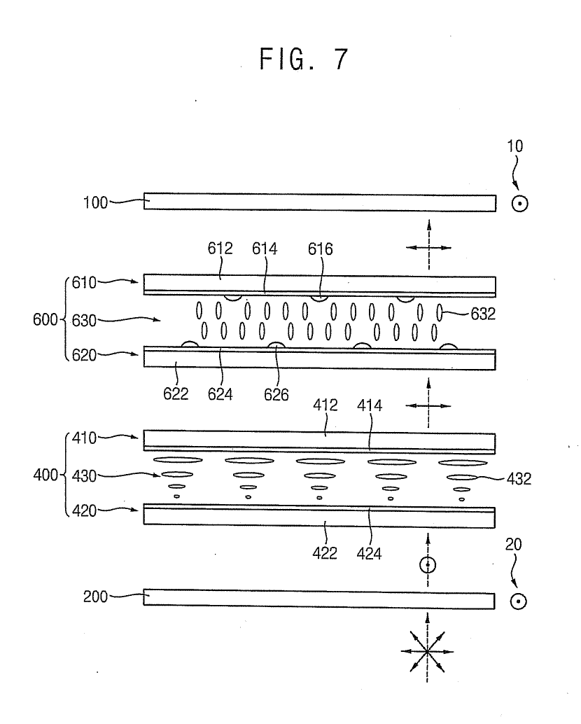

FIG. 7 is a cross-sectional view illustrating another exemplary embodiment of a display panel assembly according to the present invention. In the illustrated exemplary embodiment, the display panel assembly is the same as in FIGS. 2 and 3 except for the display panel. Thus, the same reference numerals will be used to refer to the same or like parts as those described in FIGS. 2 and 3 and any further repetitive explanation concerning the above elements will be omitted.

Referring to FIG. 7, the display panel assembly includes an upper polarizing sheet 100, a lower polarizing sheet 200, a polarizing axis changing unit 400 and a display panel 600.

The upper polarizing sheet 100 includes a first polarizing axis 10 polarizing a light in a predetermined direction.

The lower polarizing sheet 200 is disposed under the upper polarizing sheet 100 for facing the upper polarizing sheet 100, and includes a second polarizing axis 20 having a same direction as the first polarizing axis 10.

The polarizing axis changing unit 400 is disposed between the upper and lower substrates 100 and 200, for rotating a light polarized in a direction 90 degrees with respect to the direction. The polarizing axis changing unit 400 includes an upper substrate 410, a lower substrate 420 facing the upper substrate 410, and a polarizing axis changing liquid crystal layer 430 disposed between the upper and lower substrate 410 and 420. The polarizing axis changing liquid crystal layer 430 is disposed between the upper and lower substrates 410 and 420, for rotating a polarizing axis of a light 90 degrees.

The display panel 600 may be disposed between the upper polarizing sheet 100 and the polarizing axis changing unit 400 or between the lower polarizing sheet 200 and the polarizing axis changing unit 400, for changing a light-transmissivity to display images. The display panel 600 includes a first substrate 610, a second substrate 620 and a liquid crystal layer 630.

The first substrate 610 includes a first transparent substrate 612, a common electrode 614 and a plurality of first protrusion portions 616.

The first transparent substrate 612 includes a transparent material such as quartz, glass and so on. The common electrode 614 is formed on the first transparent substrate 612 and includes a transparent conductive material. A first voltage is applied to the common electrode 614 from an external voltage supply unit (not shown). The first protrusion portions 616 are protruded in a direction substantially perpendicular to the first transparent substrate 612 to have a predetermined height from a surface the common electrode 614 (or base of the protrusion). The first protrusions 616 are disposed separately from each other by a predetermined distance in a direction taken substantially parallel to the first transparent substrate 612.

In alternative exemplary embodiments, the first substrate 610 may further include color filters transmitting a light and displaying colors. The color filters, when viewed on a plane, are disposed in a substantially matrix shape.

The second substrate 620 is disposed to face the first substrate 610, and includes a second transparent substrate 622, pixel electrodes 624 and a plurality of second protrusion portions 626.

The second transparent substrate 622 includes a transparent material such as quartz, glass and so on. The pixel electrodes 624 may include a same transparent conductive material as the common electrode 614, and are formed on the second transparent substrate 622 to face the common electrode 614. The pixel electrodes 624 are arranged substantially in a matrix shape to correspond to the color filters. A second voltage is applied to the pixel electrode 624 from an external voltage supply unit (not shown) and the second voltage is different from the first voltage. The second protrusion portions 626 are protruded from the pixel electrode 624 to have a predetermined height from a surface the pixel electrode 624 (or base of the protrusion). The second protrusions 626 are disposed separately from each other by a predetermined distance in a direction taken substantially parallel to the second transparent substrate 622. In the illustrated exemplary embodiment, each of the second protrusion portions 626 is formed between adjacent first protrusion portions 616, preferably substantially in the middle position between the adjacent first protrusion portions 616.

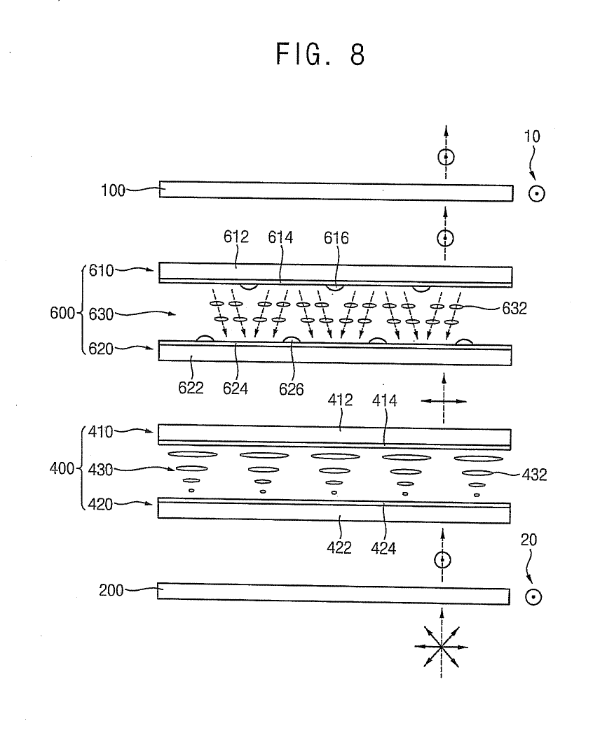

The liquid crystal layer 630 has a plurality of liquid crystal molecules 632 that are arranged between the first and second substrates 610 and 620. A longitudinal arrangement direction of liquid crystal molecules 632 is changed by an electric field generated between the first and second substrates 610 and 620. The longitudinal arrangement direction of liquid crystal molecules 632 is substantially perpendicular to the first and second substrates 610 and 620, when the electric field is not generated. The longitudinal arrangement direction of liquid crystal molecules 632 is perpendicular to the direction of the electric field, when the electric field is generated. Referring to FIG. 7 again, an advancing path of the light will be explained. The light that has passed through the lower polarizing sheet 200 is polarized to have a first direction substantially parallel with the second polarizing axis 20. Then, the light passes through the polarizing axis changing unit 400 and is rotated 90 degrees with respect to the first direction, so that the light is polarized to have a second direction substantially perpendicular to the first direction. The light that has been polarized to have the second direction passes through the display panel 600 without the electric field, but cannot pass through the upper polarizing sheet 100 having the first polarizing axis 10 that is parallel with the first direction. FIG. 8 is a cross-sectional view illustrating the display panel assembly in FIG. 7 when an electric field is generated between a first and a second substrate.

Referring to FIG. 8, the advancing path of the light when the electric field is formed in the display panel 600 will be explained. The light that has passed through the lower polarizing sheet 200 is polarized to have the first direction parallel with the second polarizing axis 20. The light passes through the polarizing axis changing unit 400 and is rotated 90 degrees with respect to the first direction, so that the light is polarized to have the second direction. The light that has been polarized to have the second direction passes through the display panel 600 with the electric field and is rotated 90 degrees with respect to the second direction, so that the light is polarized to have the first direction again. The light that has been polarized to have the first direction passes through the upper polarizing sheet 100 having the first polarizing axis 10 parallel with the first direction.

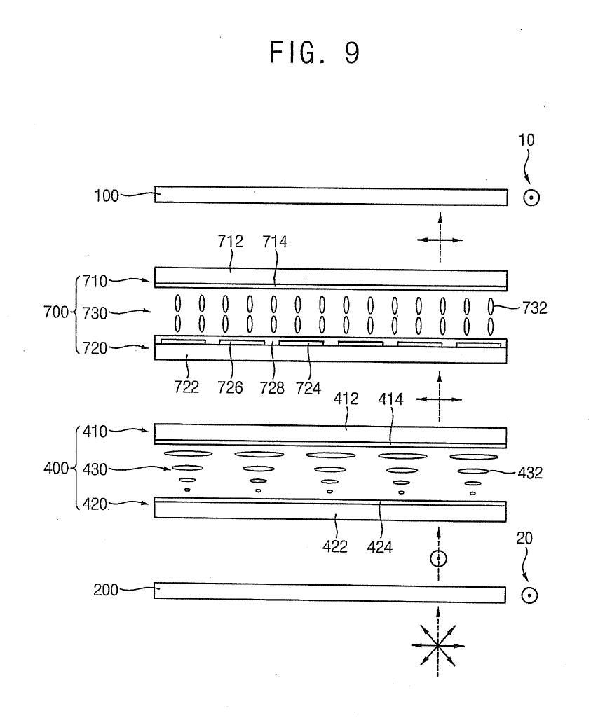

FIG. 9 is a cross-sectional view illustrating another exemplary embodiment of a display panel assembly according to the present invention. In the illustrated exemplary embodiment, the display panel assembly is the same as in FIGS. 2 and 3 except for the display panel. Thus, the same reference numerals will be used to refer to the same or like parts as those described in FIGS. 2 and 3 and any further repetitive explanation concerning the above elements will be omitted.

Referring to FIG. 9, the display panel assembly includes an upper polarizing sheet 100, a lower polarizing sheet 200, a polarizing axis changing unit 400 and a display panel 700.

The upper polarizing sheet 100 has a first polarizing axis 10 polarizing a light in a predetermined direction.

The lower polarizing sheet 200 is disposed under the upper polarizing sheet 100 to face the upper polarizing sheet 100, and has a second polarizing axis 20 having a same direction as the first polarizing axis 10.

The polarizing axis changing unit 400 is disposed between the upper and lower polarizing sheets 100 and 200, for rotating a light polarized in a direction 90 degrees with respect to the direction. The polarizing axis changing unit 400 includes an upper substrate 410, a lower substrate 420 facing the upper substrate 410, and a polarizing axis changing liquid crystal layer 430 arranged between the upper and lower substrates 410 and 420. The polarizing axis changing liquid crystal layer 430 is arranged between the upper and lower substrates 410 and 420, for rotating a polarizing axis of the light 90 degrees.

The display panel 700 may be is disposed between the upper polarizing sheet 100 and the polarizing axis changing unit 400 or between the lower polarizing sheet 200 and the polarizing axis changing unit 400, for changing a light-transmissivity to display images. The display panel 700 includes a first substrate 710, a second substrate 720 and a liquid crystal layer 730.

The first substrate 710 includes a first transparent substrate 712 and a first alignment film 714.

The first transparent substrate 712 includes a transparent material such as quartz, glass and so on. The first alignment film 714 is formed on a front surface of the first transparent substrate 712. In alternative exemplary embodiments, the first substrate 710 may further include color filters transmitting a light and displaying colors.

The second substrate 720 faces the first substrate 710, and includes a second transparent substrate 722, a first transparent electrode 724, a second transparent electrode 726 and a second alignment film 728.

The second transparent substrate 722 includes a transparent material such as quartz, glass and so on. The first and second transparent electrodes 724 and 726 may include the same transparent conductive material and are formed on the second transparent substrate 722 for facing the first alignment film 714. Particularly, the first and second transparent electrodes 724 and 726 are formed on the second transparent substrate 722 and are protruded in a direction substantially perpendicular to the second transparent substrate 722 to have a predetermined height from a surface the second transparent substrate 722. The first and second transparent electrodes 724 and 726 are disposed separated from each other by a predetermined distance in a direction taken substantially parallel to the second transparent substrate 722.

A first voltage is applied to the first transparent electrode 724 from an external voltage generating unit (not shown) and a second voltage different from the first voltage is applied to the second transparent electrode 726, so that an electric field is generated between the first and second transparent electrodes 724 and 726.

The liquid crystal layer 730 is disposed between the first and second substrates 710 and 720 and includes a plurality of liquid crystal molecules 732. A longitudinal arrangement direction of the liquid crystal molecules 732 is changed by the electric field generated between the first and second transparent electrodes 724 and 726. When the electric field is not generated, the longitudinal arrangement direction of liquid crystal molecules 732 is substantially perpendicular to the first and second substrates 710 and 720. When the electric field is generated, the longitudinal arrangement direction of the liquid crystal molecules is parallel with the direction of the electric field. In one exemplary embodiment, the liquid crystal molecules 732 are positive liquid crystal molecules having a characteristic of being arranged parallel with the direction of the electric field.

Referring to FIG. 9 again, an advancing path of the light will be explained. The light that has passed through the lower polarizing sheet 200 is polarized to have a first direction substantially parallel with the second polarizing axis 20, passes through the polarizing axis changing unit 400 and is rotated 90 degrees with respect to the first direction, so that the light is polarized to have a second direction substantially perpendicular to the first direction. The light that has been polarized to have the second direction passes through the display panel 700 without the electric field, but cannot pass through the upper polarizing sheet 100 having the first polarizing axis 10 parallel with the first direction.

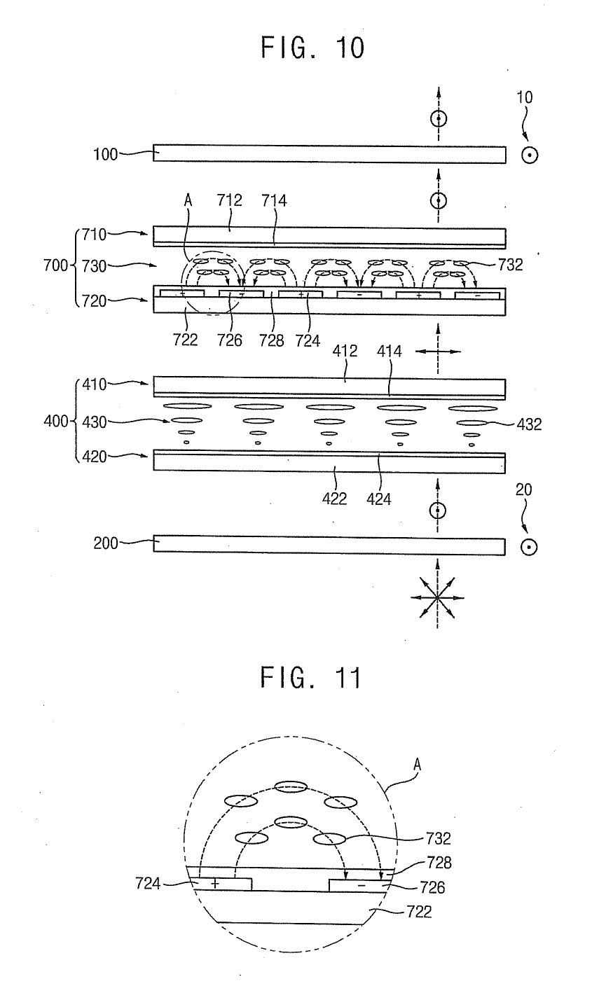

FIG. 10 is a cross-sectional view illustrating the display panel assembly in FIG. 9 when an electric field is generated between a first and a second substrate and FIG. 11 is an enlarged cross-sectional view illustrating portion ‘A’ in FIG. 10.

Referring to FIGS. 10 and 11, when different voltages are applied to the first and second transparent electrodes 724 and 726, the electric field is generated between the first and second transparent electrodes 724 and 726. Since the first and second transparent electrodes 724 and 726 are formed to be separated from each other by a predetermined distance and are formed from a same layer, the electric field generated between the first and second transparent electrodes 724 and 726 has what is considered a half-circular shape. Since the direction of the electric field is generated almost parallel with the first and second substrates 710 and 720 in a middle area between the first and second substrates 710 and 720, the liquid crystal molecules 732 being arranged between the first and second substrates 710 and 720 are arranged substantially parallel with the first and second substrates 710 and 720.

Referring to FIG. 10 again, the advancing path of the light will be explained when the electric field is generated in the display panel 700. The light that has passed through the lower polarizing sheet 200 is polarized to have the first direction substantially parallel with the second polarizing axis 20, passes through the polarizing axis changing unit 400 and is rotated 90 degrees with respect to the first direction, so that the light is polarized to have the second direction perpendicular to the first direction. The light that has been polarized to have the second direction passes through the display panel 700 with the electric field and is rotated 90 degrees with respect to the second direction, so that the light is polarized to have the first direction again. The light that has been polarized to have the first direction passes through the upper polarizing sheet 100 having the first polarizing axis 10 parallel with the first direction.

In the illustrated exemplary embodiment, the second substrate 720 includes the first and second transparent electrodes 724 and 726. In an alternative exemplary embodiment, the first substrate 710 instead of the second substrate 720 may include the first and second transparent electrodes 724 and 726.

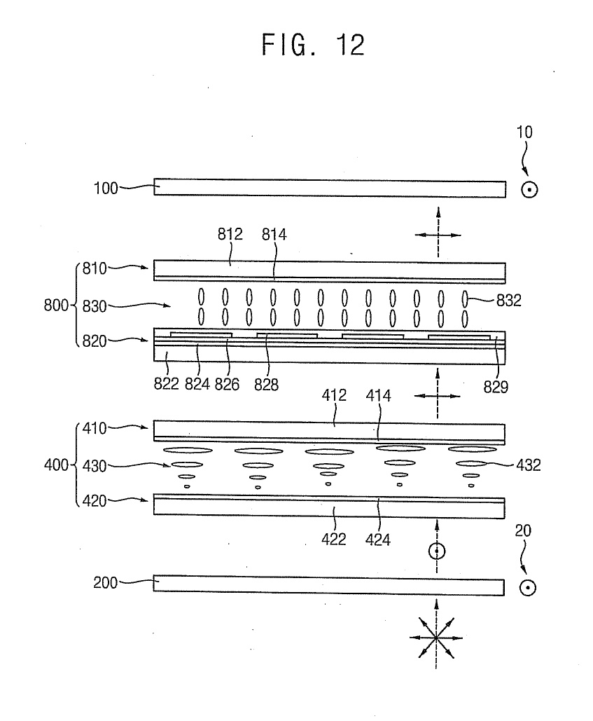

FIG. 12 is a cross-sectional view illustrating another exemplary embodiment of a display panel assembly according to the present invention. In the illustrated exemplary embodiment, the display panel assembly is the same as in FIGS. 2 and 3 except for the display panel. Thus, the same reference numerals will be used to refer to the same or like parts as those described in FIGS. 2 and 3 and any further repetitive explanation concerning the above elements will be omitted.

Referring to FIG. 12, the display panel assembly includes an upper polarizing sheet 100, a lower polarizing sheet 200, a polarizing axis changing unit 400 and a display panel 800.

The upper polarizing sheet 100 has a first polarizing axis 10 polarizing a light in a predetermined direction.

The lower polarizing sheet 200 is disposed under the upper polarizing sheet 100 for facing the upper polarizing sheet 100 and has a second polarizing axis 20 having the same direction as the first polarizing axis 10.

The polarizing axis changing unit 400 is disposed between the upper and lower polarizing sheets 100 and 200, for rotating a light polarized in a direction 90 degrees with respect to the direction. The polarizing axis changing unit 400 includes an upper substrate 410, a lower substrate 420 facing the upper substrate 410 and a polarizing axis changing liquid crystal layer 430 arranged between the upper and lower substrates 410 and 420. The polarizing axis changing liquid crystal layer 430 is arranged between the upper and lower substrates 410 and 420, for rotating a polarizing axis of the light 90 degrees.

The display panel 800 may be disposed between the upper polarizing sheet 100 and the polarizing axis changing unit 400 or between the lower polarizing sheet 200 and the polarizing axis changing unit 400, for changing a light-transmissivity to display images. The display panel 800 includes a first substrate 810, a second substrate 820 and a liquid crystal layer 830.

The first substrate 810 includes a first transparent substrate 812 and a first alignment film 814.

The first transparent substrate 812 includes a transparent material such as quartz, glass and so on. The first alignment film 814 is formed on a front surface of the first transparent substrate 812. In an alternative exemplary embodiment, the first substrate 810 may further include color filters transmitting a light and displaying colors.

The second substrate 820 faces the first substrate 810, and includes a first transparent electrode 824, an insulating layer 826, a plurality of second transparent electrodes 828 and a second alignment film 829.

The second transparent substrate 822 includes a transparent material such as quartz, glass and so on. The first transparent electrode 824 may include the same transparent material and is formed on a front surface of the second transparent substrate 822 for facing the first alignment film 814. A first voltage is applied to the first transparent electrode 824 from an external voltage generating unit (not shown).

The insulating layer 826 is formed on a front surface of the first transparent electrode 824 to have a predetermined thickness in a direction substantially lo perpendicular to the second transparent substrate 822. The plurality of second transparent electrodes 828 is disposed on a relatively small area of the insulating layer 826. The transparent electrodes 828 are protruded in a direction substantially perpendicular to the second transparent substrate 822 to have a predetermined height from a surface the second transparent substrate 822. The transparent electrodes 828 are disposed separated by a predetermined distance in a direction taken substantially parallel to the second transparent substrate 822. A second voltage different from the first voltage is applied to the second transparent electrode 828 and an electric field is generated between the first and second transparent electrodes 824 and 828.

The liquid crystal layer 830 is arranged between the first and second substrates 810 and 820 and includes a plurality of liquid crystal molecules 832. A longitudinal arrangement direction of liquid crystal molecules 832 is changed by the electric field generated between the first and second transparent electrodes 824 and 828. When the electric field is not generated, the longitudinal arrangement direction of liquid crystal molecules 832 is substantially perpendicular to the first and second substrates 810 and 820. When the electric field is generated, the longitudinal arrangement direction of liquid crystal molecules is parallel with the direction of the electric field. In one exemplary embodiment, the liquid crystal molecules 832 are positive liquid crystal molecules having a characteristic of being arranged parallel with the direction of the electric field.

Referring to FIG. 12 again, an advancing path of the light will be explained. The light that has passed through the lower polarizing sheet 200 is polarized to have a first direction parallel with the second polarizing axis 20, passes through the polarizing axis changing unit 400 and is rotated 90 degrees with respect to the first direction, so that the light is polarized to have a second direction substantially perpendicular to the first direction. The light that has been polarized to have the second direction passes through the display panel 800 without the electric field, but cannot pass through the upper polarizing sheet 100 having the first polarizing axis 10 parallel with the first direction.

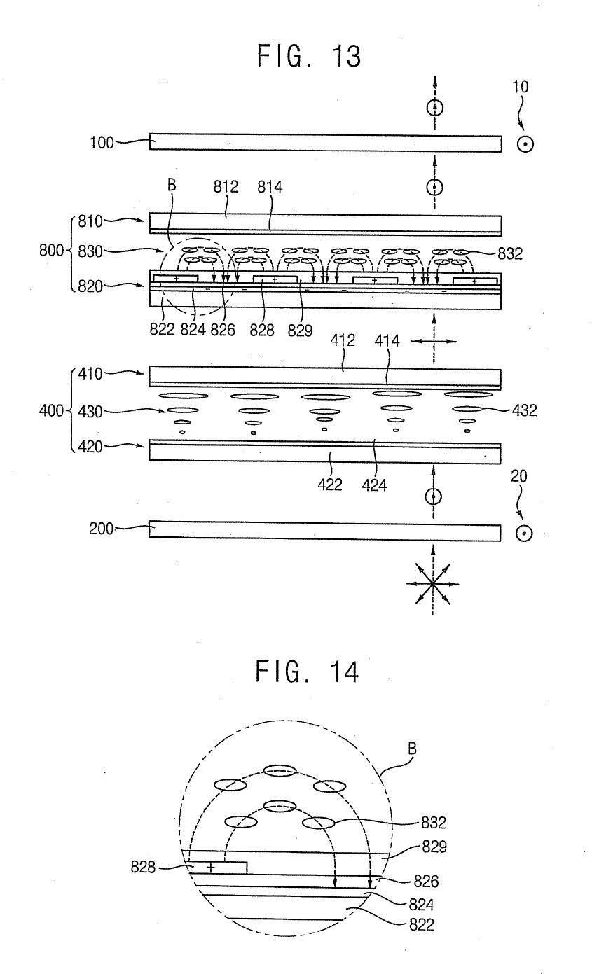

FIG. 13 is a cross-sectional view illustrating the display panel assembly in FIG. 12 when an electric field is generated between a first and a second substrate and FIG. 14 is an enlarged cross-sectional view illustrating portion ‘B’ in FIG. 13.

Referring to FIGS. 13 and 14, when the first and second transparent electrodes 824 and 828 have a voltage different from each other applied thereto, the electric field is generated between the first and second transparent electrodes 824 and 828. Since the insulating layer 826 is formed between the first and second transparent electrodes 824 and 828, the electric field generated between the first and second transparent electrodes 824 and 828 is considered to have a half-circular shape. Since the direction of the electric field is generated almost parallel with the first and second substrates 810 and 820 in a middle portion between of the first and second substrates 810 and 820, the liquid crystal molecules 832 being arranged between the first and second substrates 810 and 820 are arranged substantially parallel with the first and second substrates 810 and 820.

Referring to FIG. 13 again, the advancing path of the light will be explained when the electric field is generated in the display panel 800. The light that has passed through the lower polarizing sheet 200 is polarized to have the first direction substantially parallel with the second polarizing axis 20, passes through the polarizing axis changing unit 400 again and is rotated 90 degrees with respect to the first direction, so that the light is polarized to have the second direction. The light that has been polarized to have the second direction passes through the display panel 800 with the electric field and is rotated 90 degrees with respect to the second direction, so that the light is polarized to have the first direction again. The light that has been polarized to have the first direction passes through the upper polarizing sheet 100 having the first polarizing axis 10 parallel with the first direction.

In the illustrated exemplary embodiment, the second substrate 820 includes the first transparent electrode 824, the insulating layer 826 and the second transparent electrode 828. In an alternative exemplary embodiment, the first substrate 810 instead of the second substrate 820 may include the first transparent electrode 824, the insulating layer 826 and the second transparent electrode 828.

According to the present invention of the display panel assembly, the polarizing axis changing unit rotating the polarizing axis of the light 90 degrees, is disposed between the lower polarizing sheet and the display panel or the upper polarizing sheet and the display panel, so that the upper and lower polarizing sheet can have the same polarizing axis and can be manufactured to have a relatively larger size. Therefore, the display panel assembly can have a larger size.

Having described the example embodiments of the present invention and its advantage, it is noted that various changes, substitutions and alterations can be made herein without departing from the spirit and scope of the invention as defined by appended claims.

What is claimed is:

1. A display panel assembly comprising:
an upper polarizing sheet including a first polarizing axis;
a lower polarizing sheet facing the upper polarizing sheet, the lower polarizing sheet including a second polarizing axis having a same direction as the first polarizing axis of the upper polarizing sheet;
a display panel disposed between the upper and lower polarizing sheets and changing a light-transmissivity to display images; and
a polarizing axis changing unit disposed between the upper and lower polarizing sheets and rotating a light polarized in a predetermined direction 90 degrees with respect to the predetermined direction.

2. The display panel assembly of claim 1, wherein the polarizing axis changing unit includes:
an upper substrate;
a lower substrate facing the upper substrate; and
a polarizing axis changing liquid crystal layer disposed between the upper and lower substrates and rotating the polarized light 90 degrees with respect to the predetermined direction.

3. The display panel assembly of claim 2, wherein the polarizing axis changing liquid crystal layer includes liquid crystal molecules and a longitudinal arrangement direction of the liquid crystal molecules is substantially parallel with the upper and lower substrates, the liquid crystal molecules being rotated 90 degrees from the lower substrate toward the upper substrate.

4. The display panel assembly of claim 2, wherein the polarizing axis changing liquid crystal layer includes liquid crystal molecules and a longitudinal arrangement direction of the liquid crystal molecules is substantially parallel with the upper and lower substrates, the liquid crystal molecules having a slope of about 45 degrees with respect to the predetermined direction.

5. The display panel assembly of claim 1, wherein the polarizing axis changing unit is disposed between the lower polarizing sheet and the display panel.

6. The display panel assembly of claim 5, wherein the polarizing axis changing unit rotates the light that has passed through the lower polarizing sheet and has been polarized to have the second polarizing axis 90 degrees with respect to the second polarizing axis.

7. The display panel assembly of claim 1, wherein the polarizing axis changing unit is disposed between the upper polarizing sheet and the display panel.

8. The display panel assembly of claim 7, wherein the polarizing axis changing unit rotates the light that has passed through the display panel and having have the second polarizing axis, 90 degrees with respect to the second polarizing axis of the light.

9. The display panel assembly of claim 1, wherein the display panel includes:
a first substrate;
a second substrate facing the first substrate; and
a liquid crystal layer including a plurality of liquid crystal molecules, the liquid crystal molecules being arranged between the first and second substrates and an arrangement direction of the liquid crystal molecules being changed by an electric field generated between the first and second substrates;
and wherein the polarizing axis changing unit includes:
an upper substrate;
a lower substrate facing the upper substrate; and
a polarizing axis changing liquid crystal layer arranged between the upper and lower substrates and rotating the polarized light 90 degrees with respect to the predetermined direction.

10. The display panel assembly of claim 9, wherein a longitudinal arrangement direction of the liquid crystal molecules in the liquid crystal layer is substantially perpendicular to the first and second substrates when the electric field is not generated.

11. The display panel assembly of claim 10, wherein the first substrate includes a common electrode having a first voltage applied thereto, and wherein the second substrate includes a pixel electrode having a second voltage different from the first voltage applied thereto and generating the electric field between the first and second substrates.

12. The display panel assembly of claim 11, wherein the common electrode includes first opening portions formed through the common electrode and separated from each other by a predetermined distance,
wherein the pixel electrode includes second opening portions formed through the pixel electrode and separated from each other by a predetermined distance,
and wherein each of the first opening portions is formed substantially between adjacent second opening portions.

13. The display panel assembly of claim 11, wherein the first substrate further includes first protrusion portions protruded from the common electrode with a predetermined height and separated from each other by a predetermined distance,
wherein the second substrate further includes second protrusion portions protruded from the pixel electrode with a predetermined height and separated from each other by a predetermined distance,
and wherein each of the first protrusion portions is formed between adjacent second protrusion portions.

14. The display panel assembly of claim 11, wherein the longitudinal arrangement direction of the liquid crystal molecules in the liquid crystal layer is substantially perpendicular to a direction of the electric field.

15. The display panel assembly of claim 9, wherein one of the first and second substrates includes:
a first transparent electrode having a first voltage applied thereto; and
a second transparent electrode having a second voltage applied thereto and generating the electric field between the first transparent electrode and the second transparent electrode.

16. The display panel assembly of claim 15, wherein the first and second transparent electrodes are formed to be separated from each other by a predetermined distance and are formed from a same layer.

17. The display panel assembly of claim 15, wherein the first and second transparent electrodes are formed from different layers.

18. The display panel assembly of claim 17, further comprising an insulating layer formed between the first and second transparent electrodes.

19. The display panel assembly of claim 18, wherein the first transparent electrode is formed on an entire lower surface of the insulating layer,
and wherein a plurality of the second transparent electrodes is formed to be separated from each other by a predetermined distance on portions of an upper surface of the insulating layer.

20. The display panel assembly of claim 15, wherein a longitudinal arrangement of the liquid crystal molecules in the liquid crystal layer is parallel with a direction of the electric field.

21. The display panel assembly of claim 9, wherein the polarizing axis changing unit is disposed between the lower polarizing sheet and the display panel.

22. The display panel assembly of claim 9, wherein the polarizing axis changing unit is disposed between the upper polarizing sheet and the display panel.
